(19) United States
(12) Patent Application Publication
(10) Pub. No.: US 2003/0009325 A1
(43) Pub. Date: Jan. 9, 2003

(54) METHOD FOR SIGNAL CONTROLLED SWITCHING BETWEEN DIFFERENT AUDIO CODING SCHEMES

(76) Inventors: RAIF KIRCHHERR, LANGEN (DE); JOACHIM STEGMANN, DARMSTADT (DE)

Correspondence Address: KENYON & KENYON, ONE BROADWAY, NEW YORK, NY, 10004, US

(21) Appl. No.: 09/235,962

(22) Filed: Jan. 22, 1999

Related U.S. Application Data
(60) Provisional application No. 60/072,116, filed on Jan. 22, 1998.

(51) Int. Cl. G10L 19/14

(52) U.S. Cl. 704/211

(57) ABSTRACT

A method for signal controlled switching between audio coding schemes includes receiving input audio signals, classifying a first set of the input audio signals as speech or non-speech signals, coding the speech signals using a time domain coding scheme, and coding the nonspeech signals using a transform coding scheme. A multicode coder has an audio signal input and a switch for receiving the audio signal inputs, the switch having a time domain encoder, a transform encoder, and a signal classifier for classifying the audio signals generally as speech or non-speech, the signal classifier directing speech audio signals to the time domain encoder and non-speech audio signals to the transform encoder. A multicode decoder is also provided.

### FIELD OF THE INVENTION

The present invention relates to a method and device for coding audio signals.

### RELATED TECHNOLOGY

Audio signals, such as speech, background noise and music, can be converted to digital data using audio coding schemes. Input audio signals typically are sampled a certain frequency, and are assigned a number of bits per sample according to the audio coding scheme used. The bits, as digital data, then can be transmitted. After transmission, a decoder can decode the digital data, and output an analog signal, to, for example, a loudspeaker.

One coding scheme, PCM (pulse-code modulation), may sample telephone speech (typically 300-3400 Hz) at 8 kHz and require 8 PCM bits per sample, resulting in a 64 kb/sec digital stream. With PCM, wideband speech (typically 60-7000 kHz) may be sampled at 16 kHz and assigned 14 PCM bits per sample, resulting in a PCM bit rate of 224 kb/s. And wideband audio (typically 10-20,000 Hz) may be sampled at 48 kHz and assigned 16 PCM bits per sample, resulting in a PCM bit rate of 768 kb/s.

As described in “The ISDN Studio” by Dave Immer, Audio Engineering Society 99th Convention, Oct. 8, 1995, New York City, other audio coding techniques can be used to achieve bit rates smaller than the PCM bit rates. These audio coding schemes disregard irrelevant or redundant information and fall into two basic categories: transform (frequency domain) based schemes and time domain (predictive) based schemes. A frequency domain based scheme employs bit reduction using known characteristics (contained in an on-board lookup table) of human hearing. This bit reduction process is also known as perceptual coding. Psychoacoustic waveform information is transmitted by the digital data and reconstructed at a decoder. Aliasing noise typically is masked within subbands which contain the most energy. Audio frequency response for frequency domain coding is much less bit rate dependent than a time domain process. However, more coding delay may result.

Time domain coding techniques use predictive analysis based on look-up tables available to the encoder, and transmit differences between a prediction and an actual sample. Redundant information can be added back at the decoder. With time domain based coding techniques, audio frequency response is dependent on the bit rate. However, a very low coding delay results.

One time domain based coding scheme is CELP (code-excited linear prediction). CELP can be used to code telephone speech signals using as low as a 16 kb/s data rate. The input speech may be divided into frames at an 8 kHz sampling rate. Using a codebook of excitation waveforms and a closed-loop search mechanism for identifying the best excitation waveform for each frame, the CELP algorithm can provide the equivalent of 2 bits per sample to adequately code the speech, so that a bit rate of 16 kb/s is achieved. With wideband speech up to 7 kHz, a 16 kHz sampling may be used, also with the equivalent of 2 bits per sample, so that a bit rate of 32 kb/s can be achieved.

CELP has the advantage that speech signals can be transmitted at low bit rates, even at 16 kb/sec.

One transform coding scheme is ATC (adaptive transform coder). Audio signals are received sampled, and divided into frames. A transform, such as MDCT (modified discrete cosign transform), is performed on the frames, so that transform coefficients may be computed. The calculation of the coefficients using MDCT is explained, for example, in “High-Quality Audio Transform Coding at 64 Kbps,” by Y. Mahieux & J. P. Petit, IEEE Trans. on Communications, Vol. 42, No. 11, November 1994, which is hereby incorporated by reference herein. The MDCT coefficients then can be bit coded, and transmitted digitally.

ATC coding has the advantage of providing high quality audio transmission for signals such as music and background noise.

To date, typically only one type of coding technique has been used to code input audio signals in a codec system. However, especially at low bit rates, this does not lead to an optimal transfer of audio signals due to the limitations of time domain and transform coding techniques.

### SUMMARY OF THE INVENTION

The present invention provides for the use of both frequency and time domain coding at different times, so that, depending on the available bandwidth, digital transfer of audio signals can be optimized.

The present invention thus provide a method for signal controlled switching comprising:

receiving input audio signals;

classifying a first set of the input audio signals as speech or non-speech signals;

coding the speech signals using a time domain coding scheme; and

coding the nonspeech signals using a transform coding scheme.

The time domain coding scheme preferably is a CELP coding scheme and the transform coding scheme a ATC coding scheme. The method of the present invention thus can use an ATCELP coder which is a combination of an ATC coding scheme and a CELP coding scheme.

The time domain coding scheme is used mainly for speech signals and the transform coding scheme is used mainly for music and stationary background noise signals, thus providing advantages of both types of coding schemes.

The present method preferably is used only when a bandwidth of less than 32 kb/sec is available, for example 16 kb/sec or 24 kb/sec. For a bit rate of 32 kb/s or higher, only the transform mode of a multicode coder then is used.

The present invention also provides a multicode coder comprising:

an audio signal input; and

a switch for receiving the audio signal inputs, the switch having a time domain encoder, a transform encoder, and a signal classifier for classifying the audio signals generally as speech or non-speech, the signal classifier directing speech audio signals to the time domain encoder and non-speech audio signals to the transform encoder.

The time domain encoder preferably is a CELP encoder and the transform encoder an ATC encoder. The change between these two coding techniques (CELP and ATC) is controlled by the signal classifier, which works exclusively on the audio input signal. The chosen mode (speech or non-speech) of the signal classifier can be transmitted as side information to the decoder.

The present invention also provides a multicode decoder having a transform decoder, a time domain decoder and an output switch for switching signals between the transform and time domain decoders.

### BRIEF DESCRIPTION OF THE DRAWINGS

The present invention may be understood in conjunction with the drawings, in which:

FIG. 1 shows a multicode coder according to the present invention;

FIG. 2 shows a multicode decoder according to the present invention;

FIGS. 2a and 2b show the functioning of a multicode decoder according to the present invention during transitions between an ATC mode and a CELP mode.

FIG. 3 shows a block diagram of a CELP encoder of the present invention;

FIG. 4 shows a block diagram of the CELP decoder of the present invention;

FIG. 5 shows a block diagram of the ATC encoder of the present invention;

FIG. 6 shows a block diagram of the ATC decoder o f the present invention;

FIG. 7 shows a block diagram of the valid frame decoder show n in FIG. 6; and

FIG. 8 shows a block diagram of the error concealment unit shown in FIG. 6.

### DETAILED DESCRIPTION

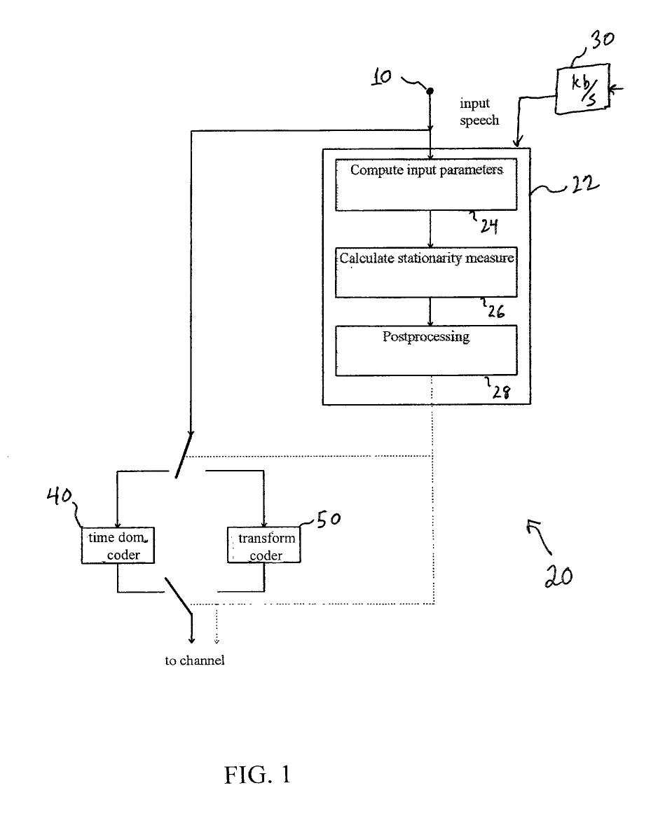

FIG. 1 shows a schematic block diagram of a multicode coder. Audio signals are input at an audio signal input 10 to a switch 20. The switch 20 provides the audio signals to a signal classifier 22. A bandwidth input 30 which can be set to the relevant data bit rate also is connected to the switch 20.

The switch 20 can direct the input audio signals to either a time domain encoder 40 or a transform encoder 50.

The digital output of the encoder 40 or 50 is then transferred over a channel. The switch 20 also has a classifier output 26 connected to the channel.

The multicode coder functions as follows:

The input signal at signal input 10 is sampled at 16 kHz and processed frame by frame based on a frame length of 320 samples (20 ms) using a lookahead of one frame. The coder thus has a coder delay of 40 ms, 20 ms for the processed frame and 20 ms for the lookahead frame, which can be stored temporarily in a buffer.

The signal classifier 22 is used when the bandwidth input 30 indicates an available bandwidth less than 32 kb/sec, for example bit rates of 16 and 24 kb/s, and classifies the audio signals so that the switch 20 sends speech-type signals through the time domain encoder 40 and non-speech type signals, such as music or stationary background noise signals, through the transform encoder 50.

For a bit rate of 32 kb/s or greater, the switch 20 operates so that the switch always transfers signals through the transform encoder 50.

For lower bit rates of 16 and 24 kb/s, the switch 20 operates so that first the signal classifier 22 calculates a set of input parameters from the current audio frame, as shown in block 24. After that, a preliminary decision is computed using a set of heuristically defined logical operations, as shown in block 26.

Finally as shown in block 28, a postprocessing procedure is applied to guarantee that switching is performed only during frames that allow a smooth transition from one mode to another.

The audio input, which in this case may be bandwidth limited to 7 kHz, i.e., to a wideband speech range, can be classified as speech or non-speech. At block 24, the signal classifier 22 first computes two prediction gains, a first prediction gain being based on an LPC (linear prediction) analysis of the current input speech frame and a second prediction gain being based on a higher order LPC analysis of the previous input frames. Therefore the second prediction gain is similar to a backward LPC analysis based on coefficients that are derived from the input samples instead of synthesized output speech.

An additional input parameter for the determining of a stationarity measure by the switch is the difference between previous and current LSF (line-spectrum frequency) coefficients, which are computed based on a LPC analysis of the current speech frame.

As shown schematically in block 26, the difference of the first and second prediction gains and the difference of the previous and current LSF coefficients are used to derive the stationarity measure, which is used as an indicator for the current frame being either music or speech. All the thresholds for the logical operations may be derived from the observation of a large amount of speech and music signals. Special conditions are checked for noisy speech.

As shown schematically in block 28, before any switch between the time domain mode and the transform mode occurs, a final test procedure is performed in the signal classifier 22 to examine if the transition of one mode to another will lead to a smooth output signal at the decoder. In order to reduce complexity, this test procedure is performed on the input signal. If it is likely that switching will lead to an audible degradation, the decision to switch modes is delayed to the next frame.

The test procedure in block 28 is as follows: if the classifier 22 in block 26 decides to perform a transition from the transform mode to the time domain mode at frame n, the nth frame is the last frame to be computed by the transform scheme using a modified window function. The modified window function used for frames n and (n+1) is set to zero for the last 80 samples. This enables the transform coder to encode the leading 80 samples of frame (n+1). Otherwise, this would cause aliasing effects, because the overlapping of successive window functions is not possible without the transform coefficients of the next frame. In the (n+1)th frame, where the time domain mode is performed for the first time, only the last 5 ms can be encoded by the time domain coder (caused by a filterbank delay), so that in this frame 10 ms of the speech signal will have to be extrapolated at the decoder side.

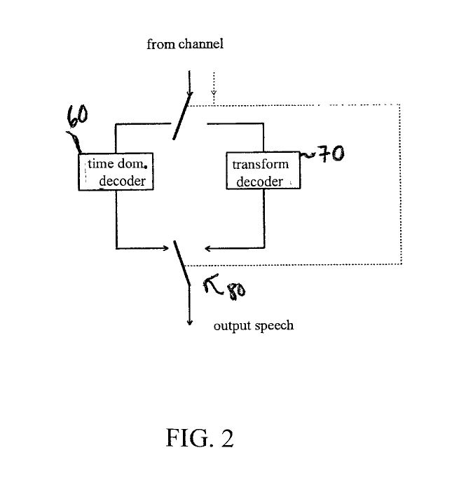

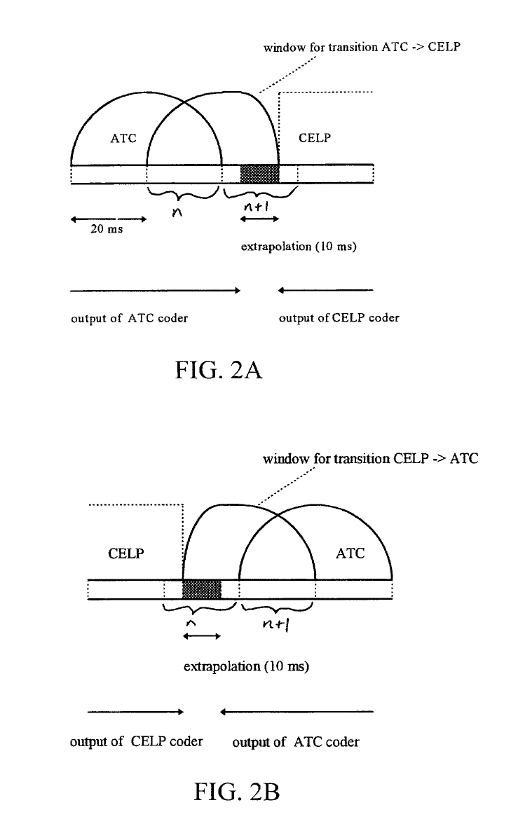

FIG. 2a shows this transition for an ATC to a CELP mode change. As can be seen, in the (n+1)th frame, the first 5 ms of the frame are ATC encoded and the last 5ms of the frame are CELP encoded. The extrapolation for the 10 ms takes place in the multicode decoder. As shown in FIG. 2, the multicode decoder of the present invention has a time domain decoder 60, a transform decoder 70 and an output switch 80.

If the signal classifier 22 in block 26 of FIG. 1 on the other hand decides to perform a transition from the time domain mode to the transform mode at input frame n, the first frame which is encoded by the transform scheme is frame number n. This transform encoding is done using a modified window function similar to the one used at the ATC to CELP transition shown in FIG. 2a, but reversed in time, as shown in FIG. 2b using ATC as an example of the transform scheme and CELP as an example of the time domain scheme. This enables the transform scheme to decode the last 80 samples of frame number n. The first 5 ms of this transition frame (number n) can be decoded from the last transmitted time domain coefficients.

Therefore extrapolation at the decoder also is performed for a length of 10 ms, as shown in FIG. 2b.

Extrapolation is performed by calculating a residual signal of some of the previous synthesized output frames, which are extended according to pitch lag and then filtered using the LPC synthesis-filter. The LPC coefficients are computed by a backward LPC analysis of the last synthesized output frames. The open loop pitch calculation can be similar to that of a CELP coding scheme.

To avoid discontinuities at the end of the extrapolated signal, extrapolation is performed for a length of 15 ms, where the last 5 ms of the extrapolated signal is weighted with a sine²-window function and added to the correspondingly weighted synthesized samples of the coding scheme used.

If the extrapolated signal is very similar to the original input signal, the probability of a smooth transition at the decoder is high and the transition can be preformed. If not, the transition can be delayed.

Preferably, the transform and time domain coding schemes used in the encoders and decoders in FIGS. 1 and 2 are modified ATC and CELP coding schemes, respectively. In these schemes two additional mode bits are provided in the coding scheme for ATC/CELP changeover information. These two bits are taken from the bits typically used for the coding of the ATC-coefficients or from the bits for the CELP error protection, respectively.

The four transmitted modes are:

| | |
|---|---|
| Mode 0: | CELP mode (continue CELP mode) |
| Mode 1: | transition mode- ATC → CELP |
| Mode 2: | transition mode: CELP → ATC |
| Mode 3: | ATC mode (continue ATC mode). |

The two bits of information thus can identify the mode for the relevant frame. Of course, for coding schemes other than ATC and CELP, these 2 bits can be transmitted as well within those coding schemes. Thus the following description with respect to CELP and ATC is relevant as well to other time domain and transform domain coding techniques, respectively.

The present invention also can provide error concealment for frame erasures. If a frame erasure occurs and the last frame was processed in mode 0 (for example CELP), then the CELP-mode will be kept for this frame. Otherwise, if the last frame was not processed in mode 0, then the erased frame will be handled like an erased ATC frame.

If a frame indicating a transition from ATC to CELP (i.e., mode 1) is erased, an ATC bad frame handling (ATC-BFH) will be used, since the previous frame was an ATC (mode 3)-frame. However, since the following non-erased frame is already a CELP frame (mode 0), a signal extrapolation covering 15 ms should be performed.

One the other hand, if a frame indicating a transition from CELP to ATC (i.e., mode 2) is erased, a CELP-BFH (bad frame handling) operation is used. Upon the detection of the following non-erased frame, which is in ATC mode (mode 3), an extra ATC-BFH has to be performed in order to enable the decoding of the non-erased ATC frame.

The frame erasure concealments of each individual coding scheme are described further below.

As stated above, the present invention preferably uses a CELP scheme as the time domain coding scheme performed by encoder 40 of FIG. 1. The CELP scheme can be a subband-CELP (SB-CELP) wideband source coding scheme for bit rates of 16 kbit/s and 24 kbit/s.

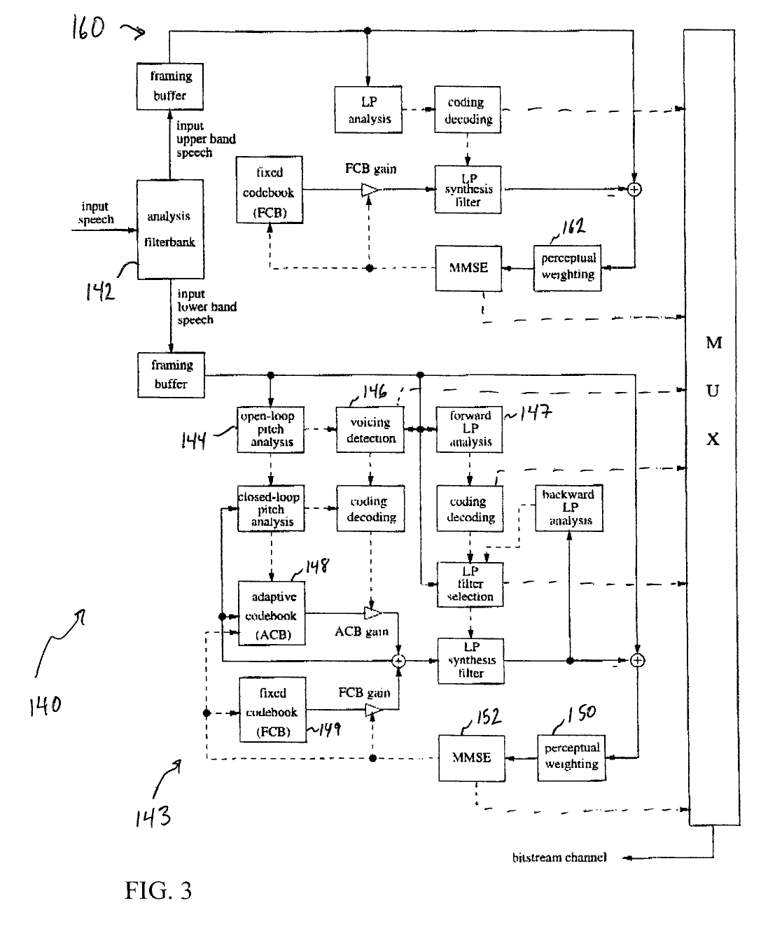

FIG. 3 shows a block diagram of a SB-CELP encoder 140. The coding scheme is based on a split-band scheme with two unequal subbands using an ACELP (algebraic code excited linear prediction) codec in the lower subband. The CELP encoder 140 operates on a split-band scheme using two unequal subbands from 0-5 kHz and 5-7 kHz. The input signal is sampled at 16 kHz and processed with a frame length of 320 samples (20 ms).

A filterbank 142 performs unequal subband splitting and critical subsampling of the 2 subbands. Since the input signal typically is bandlimited to 7 kHz, the sampling rate of the upper band can be reduced to 4 kHz. At the output of the analysis filterbank 142, one frame of the upper band (5-7 kHz) has 80 samples (20 ms). One frame of the lower band (0-5 kHz) has 200 samples (20 ms), according to a sampling frequency of 10 kHz. The delay of the analysis filterbank amounts to 5 ms.

The 0-5 kHz band is encoded using ACELP, taking place in lowerband subcoder 143. The subframe lengths used for the different parts of the codec are indicated in Table 1, being 5 ms for the LTP or adaptive codebook (ACB) and 1 . . . 2.5 ms for the fixed codebook (FCB) parameters. A voicing mode can be switched every 10 ms.

TABLE 1
Update of the lower band codec parameters (in samples, fₛ = 10 kHz)

| | name of update | length of update period | |
|---|---|---|---|
| Parameter | period | 16 kbit/s | 24 kbit/s |
| LPC | frame | 200 (20 ms) | |
| LTP mode | open-loop frame | 100 (10 ms) | |
| ACB parameters | ACB subframe | 50 (5 ms) | |
| FCB parameters | FCB subframe | 25 (2.5 ms) | 10 (1.0 ms) |

Linear prediction analysis within the lower band subcoder 143 occurs such that the short term (LP) synthesis filter coefficients are updated every 20 ms. Depending on tile input signal characteristics, different LP methods are used. For speech and strongly unstationary music passages, the forward mode through block 147 is chosen, i.e., a low order (Nₚ=12) LP model is computed from the current frame and the coefficients are transmitted. To obtain the LP parameters, an autocorrelation approach is applied to a windowed 30 ms segment of the signal input signal. A look-ahead of 5 ms is used. The quantization of the 12 forward LP parameters is performed in the LSF (Line Spectral Frequencies) domain using 33 bits. Particularly for rather stationary music passages, typically the backward mode, a high order LP filter (Nₚ=52) would be adapted from a 35 ms segment of the previously synthesized signal. Therefore, no further LP parameter information has to be transmitted. However, with the multicode coder of the present invention this backward mode need not be used, as the transform coding scheme can code stationary music passages.

The LPC mode switch is based on the prediction gains of the forward and backward LPC filters and a stationarity indicator. A mode bit is transmitted to the decoder to indicate the LPC mode for the current frame. In the forward LPC mode, the synthesis filter parameters are linearly interpolated in the LSF domain. As stated, the backward mode is not used in the present invention, and thus the LPC mode switch always is set to choose the forward mode.

The pitch analysis and adaptive codebook (ACB) search of the lower band coder 143 are as follows: depending on the voicing mode of the input signal, a long-term-prediction filter (LTP) is calculated by a combination of open-loop and closed-loop LTP analysis. For each 10 ms half of the frame (open-loop, or OL, frame), an open-loop pitch estimate is calculated in block 144 using a weighted correlation measure. Depending on this estimate and the input signal, a voicing decision at block 146 is taken and coded by a mode bit.

Provided an OL frame declared voiced, a constrained closed-loop adaptive codebook search through the ACB in block 148 is performed around the open-loop estimate in the first and third ACB-subframe. In the second and fourth ACB-subframe a restricted search is performed around the pitch lag of the closed-loop analysis of the first or third ACB subframe, respectively.

This procedure results in a delta encoding scheme leading to 8+6=14 bits per OL frame for coding the pitch lags in the range of 25 . . . 175. A fractional pitch approach is used.

For each ACB subframe, the pitch gain is nonuniformly scalar quantized with 4 bits. Therefore, the total bit rate of LTP amounts to 22 bits per OL frame.

For bit rates of 16 kb/s, the following fixed codebook search through block 149 is used by the CELP scheme in subcoder 143.

Every 2.5 ms (25 samples), an excitation shape vector is selected from a ternary sparse codebook (“pulse codebook”).

Depending on the bit rate available for the excitation, i.e., depending on the settings of the LPC mode and voicing mode switches, different configurations of the algebraic codebook are selected:

An innovation vector contains 4 or 5 tracks with a total maximum of 10 or 12 nonzero pulses, resulting to bit rates of 25 to 34 bits to encode a shape vector. The FCB gain is encoded using fixed interframe MA prediction of the logarithmic energy of the scaled excitation vector. The prediction residual is nonuniformly scalar quantized using 4 or 5 bits, also depending on the available bit rate.

At bit rates of 24 kb/s, the following fixed codebook search is used:

Every 1 ms (10 samples), an excitation shape vector is selected from either a sparse ternary algebraic codebook (“pulse codebook”) or a ternary algebraic codebook with constrained zero samples (“ternary codebook”).

Depending on the bit rate available for the excitation, i.e., depending on the settings of the LPC mode and voicing mode switches, different configurations of the algebraic codebooks are selected. For the pulse codebook, an innovation vector contains 2 tracks with a total maximum of 2 or 3 nonzero pulses, resulting to bit rates of 12, 14, or 16 bits to encode. For the ternary codebook, a shape vector is encoded using 12, 14, or 16 bits, too. Both codebooks are searched for the optimum innovation and that codebook type is selected which minimizes the reconstruction error. For each FCB subframe, the FCB mode is transmitted by a separate bit. The FCB gain is encoded using fixed interframe MA prediction of the logarithmic energy of the scaled excitation vector. The prediction residual is nonuniformly scalar quantized using 3 or 4 bits, also depending on the available bit rate.

A perceptual weighting filter in block 150 is used during the minimization process of the ACB and FCB search (through minimum mean square error block 152). This filter has a transfer function of the form W(z)=A(z/y₁)/A(z/y₂), with A (z) being the LP analysis filter. Different sets of weighting factors are used during the ACB and FCB search. The perceptual weighting filter is updated and interpolated as the LP synthesis filter. In the forward LPC mode, the weighting filter coefficients are computed from the unquantized LSF. (In the backward LPC mode, the weighting filter typically is computed from the backward LP coefficients and extended by a tilt compensation section.)

Encoding of the upper band (5-7 kHz) takes place in upper band subcoder 160 as follows.

For bit rates of 16 kb/s, the upper band is not transmitted, and thus not encoded.

At 24 kb/s, the decimated upper subband is encoded using code-excited linear prediction (CELP) technique.

The coder operates on signal frames of 20 ms (80 samples at a sampling rate of 4 kHz). An upper band frame is divided into 5 excitation (FCB) subframes of length 16 samples (4 ms). The short term (LP) synthesis filter coefficients for a model order of Nₚ₌8 are computed applying a Burg covariance approach to a input segment of length 160 (40 ms) and quantized with 10 bits.

From the LP parameters, a perceptual weighting filter (indicated at block 162) having a transfer function of the form W(z)=A(z/y₁/A(z/y₂), with A(z) representing the inverse LP filter, is computed for the fixed codebook (FCB) search.

In the upper band FCB search, an innovation shape vector of length 16 samples is chosen from a 10 bit stochastic Gaussian codebook. The FCB gain is encoded using fixed interframe MA prediction, with the residual being nonuniformly scalar quantized with 3 bits.

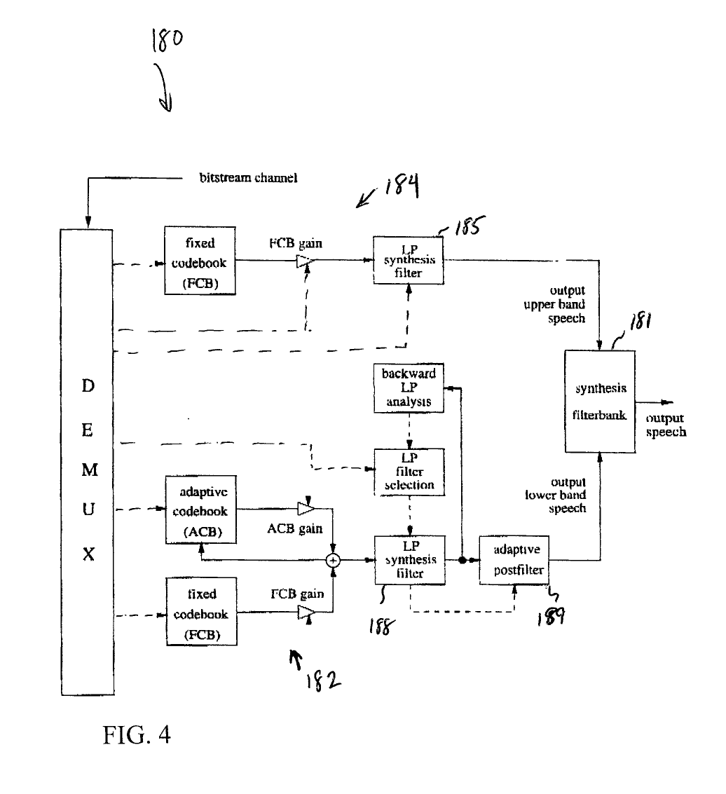

FIG. 4 shows a CELP decoder 180 for decoding received CELP encoded signals. The decoding of the 0-5 kHz band takes place in a lower band subdecoder 182 such that the total excitation is constructed from the received (adaptive and fixed) codebook indices and codeword gains, depending on the mode and the bit rate. This excitation is passed through the LP synthesis filter 188 and an adaptive postfilter 189.

According to the encoder procedures, either the received LP coefficients are used for the LP synthesis filter during the forward modes; or, for the backward modes, a high order filter is computed from the previously synthesized signal before postfiltering.

The adaptive postfilter 189 has a cascade of a format postfilter, a harmonic postfilter, and a tilt compensation filter. After postfiltering, an adaptive gain is performed. The postfilter is not active during backward LPC mode.

The 5-7 kHz band is decoded in upper band subdecoder 184 as follows. At 16 kb/s, no upper band parameters have been transmitted. The upper band output signal is set to zero by the decoder.

At 24 kbit/s, the received parameters are decoded. Every 4 ms, a vector of 16 samples is generated from the received FCB entry and a gain is computed using the received residual and the locally predicted estimate. This excitation is passed through the LP synthesis filter 185.

After decoding the two subband signals, a synthesis filterbank 181 provides unsampling, interpolation and a delay compensated superposition of these signals, having the inverse structure as the analysis filterbank. The synthesis filterbank contributes 5 ms of delay.

Bit error concealment is provided by the decoder 180. Depending on the bit rate and mode, different numbers of (parity) bits are available. Single parity bits are assigned to particular codec parameters, in order to locate errors and to take dedicated interpolative measures for concealment. Bit error protection is important especially for the LPC mode bit, the LP coefficients, pitch lags and fixed codebook gains.

Frame erasure concealment also is provided. When a frame erasure is detected, the LP synthesis filter of the previous frame is re-used. Based on a voiced/unvoiced decision of the previous frame, either a pitch-synchronous or an asynchronous extrapolation of the previous excitation is constructed and used for synthesizing the signal in the current, lost frame. For subsequent lost frames, an attenuation of the excitation is performed.

Tables 2 and 3 give the bit allocation for the 16 and 24 kbit/s modes, respectively, of the CELP scheme of FIG. 3.

TABLE 2
Bit allocation for a 20 ms frame of the 16 kbit/s mode codec
16 kbit/s

| | Parameter | allocated bits |
|---|---|---|
| lower band | LPC mode | 1 |
| | voicing mode | 2 |
| | LP coeff. | 33 |
| | ACB lag | (0 or 14) + (0 or 14) |
| | ACB gain | (0 or 8) + (0 or 8) |
| | FCB shape | (100, 120 or 136) + (100, 120 or 136) |
| | FCB gain | (16 or 18) + (16 or 18) |
| upper band | | — |

| | |
|---|---|
| error protection | 1 . . . 9 |
| Total | 320 |

TABLE 3
Bit allocation for a 20 ms frame of the 24 kbit/s mode codec
24 kbit/s

| | Parameter | allocated bits |
|---|---|---|
| lower band | LPC mode | 1 |
| | voicing mode | 2 |
| | LP coeff. | 33 |
| | ACB lag | (0 or 14) + (0 or 14) |
| | ACB gain | (0 or 8) + (0 or 8) |
| | FCB mode | 20 |
| | FCB shape | (120, 140 or 160) + (120, 140 or 160) |
| | FCB gain | (31, 32, 33 or 34) + (31, 32, 33 or 34) |
| upper band | LP coeff. | 10 |
| | FCB shape | 40 |
| | FCB gain | 15 |

| | |
|---|---|
| error protection | 4 . . . 11 |
| Total | 480 |

The transform coding scheme performed by the transform encoder 50 of FIG. 1 preferably is an ATC coding scheme, which operates as follows:

Transform coding is the only mode for a 32 kbit/s bit rate. For lower bit rates it is used in conjunction with the time domain coding technique in the multicode coder.

The ATC encoder may be based on an MDCT transform, which exploits psychoacoustical results by the use of masking curves calculated in the transform domain. Those curves are employed to allocate dynamically the bit rate of the transform coefficients.

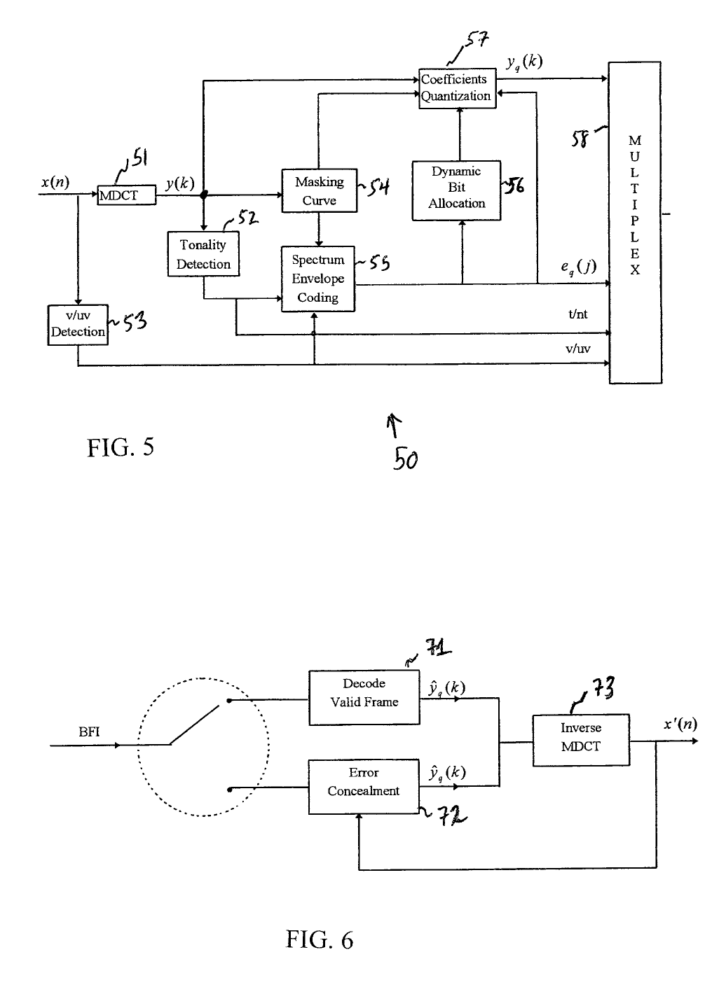

The ATC encoder 50 is depicted in FIG. 5. The input signal sampled at 16 kHz is divided into 20-ms frames. Then for each 20 ms frame, 320 MDCT coefficients of the MDCT transform are calculated, as shown in block 51, with a window overlapping two 20 ms successive frames. A tonality detector 52 evaluates whether the input signal is tonal or not, this binary information (t/nt) is transmitted to the decoder. Then a voiced/unvoiced detector 53 outputs the v/uv information.

A masking curve is calculated at block 54 using the transform coefficients, and coefficients below the mask minus a given threshold are cleared.

The spectrum envelope of the current frame is estimated at block 55, divided into 32 bands whose energies are quantized, encoded using entropy coding and transmitted to the decoder. The quantization of the spectrum envelope depends on the tonal/non tonal and voiced/unvoiced nature of the signal.

Then for the not fully masked bands a dynamic allocation of the bits for the coefficients encoding is performed at block 56. This allocation uses the decoded spectrum envelope and is performed both by the encoder 50 and the decoder. This avoids transmitting any information on the bit allocation.

The transform coefficients are then quantized at block 57 using the decoded spectrum envelope to reduce the dynamic range of the quantizer. Multiplexing is provided at block 58.

For the ATCELP (combined ATC-CELP coding), a local decoding is included. The local decoding scheme follows valid frame decoding, shown in block 71 in FIG. 6. The actual decoding of the quantization indices is generally not needed, the decoded value being a by-product of the quantization process.

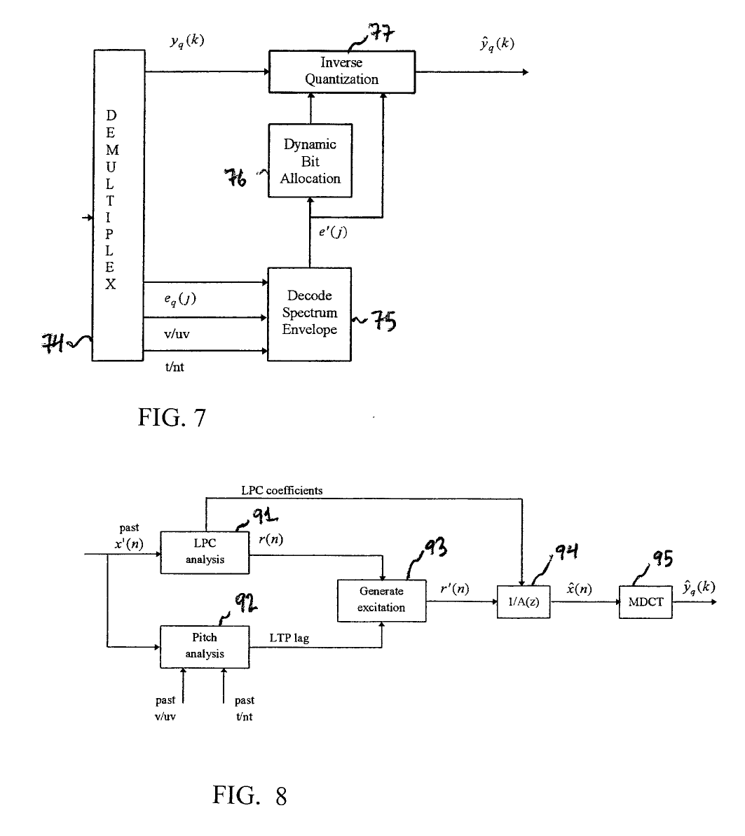

The paragraphs following below present a more detailed description of the ATC encoder 50, then the decoder 71 is described and the blocks specific to the decoder part presented in more detail in FIG. 7.

The MDCT coefficients, denoted y(k), of each frame are computed using the expression that can be found in “High-Quality Audio Transform Coding at 64 Kbps,” by Y. Mahieux & J. P. Petit, IEEE Trans. on Communications, Vol. 42, No. 1, November 1994, which is hereby incorporated by reference herein.

Because of ITU-T wideband characteristics (bandwidth limited to 7 kHz), the coefficients in the range [289,319] receive the value 0 and are not encoded. For a 16 kb/s bit rate, because of the 5 kHz low-pass limitation, this non-encoded range is extended to the coefficients [202,319].

A conventional voiced/unvoiced detection at block 53 in FIG. 5 is performed on the current input signal x(n), using the average frame energy, the 1^{st} parcor value, and the number of zero crossings.

A measure of the tonal or non-tonal nature of the input signal also is performed at block 52 on the MDCT coefficients.

A spectrum flatness measure sfm is first evaluated as the logarithm of the ratio between the geometric mean and the arithmetic mean of the squared transform coefficients. A smoothing procedure is applied to the sfm to avoid abrupt changes. The resulting value is compared to a fixed threshold to decide whether the current frame is tonal or not.

Masked coefficients also can be detected at block 54. The masking curve computation can follow the algorithm presented in “High-Quality Audio Transform Coding at 64 Kbps,” by Y. Mahieux & J. P. Petit cited above. A masking threshold is calculated for every MDCT coefficient. The algorithm uses a psychoacoustical model that gives a masking curve expression on the Bark scale. The frequency range is divided into 32 bands non-uniformly spaced along the frequency axis, as shown in Table 4. All the frequency depending parameters are assumed to be constant over each band, translated into the transform coefficients frequency grid, and stored.

Each coefficient y(k) is considered as masked when its squared value is below the threshold.

TABLE 4
Definition of the MDCT 32 bands

| | Upper | | | Upper | |
|---|---|---|---|---|---|
| | bound | Nb. Of | | bound | Nb. of |
| BAND | (Hz) | coefficients | BAND | (HZ) | coefficients |
| 0 | 75 | 3 | 16 | 2375 | 10 |
| 1 | 150 | 3 | 17 | 2625 | 10 |
| 2 | 225 | 3 | 18 | 2875 | 10 |
| 3 | 300 | 3 | 19 | 3175 | 12 |
| 4 | 375 | 3 | 20 | 3475 | 12 |
| 5 | 475 | 4 | 21 | 3775 | 12 |
| 6 | 575 | 4 | 22 | 4075 | 12 |
| 7 | 675 | 4 | 23 | 4400 | 13 |
| 8 | 800 | 5 | 24 | 4725 | 13 |
| 9 | 925 | 5 | 25 | 5050 | 13 |
| 10 | 1050 | 5 | 26 | 5400 | 14 |
| 11 | 1225 | 7 | 27 | 5750 | 14 |
| 12 | 1425 | 8 | 28 | 6100 | 14 |
| 13 | 1650 | 9 | 29 | 6475 | 15 |
| 14 | 1875 | 9 | 30 | 6850 | 15 |
| 15 | 2125 | 10 | 31 | 7225 | 15 |

A spectrum envelope is computed for each band at block 55. The spectrum envelope (e(j),j=0 to 31) is defined as the square root of the average energy in each band. The quantization of the values e(j) is different for tonal and for non-tonal frames. The 32 decoded values of the spectrum envelope will be denoted e′(j). At 16 kbit/s, only 26 bands are encoded, since the coefficients in the range [202,319] are not encoded and receive the value zero.

For non tonal frames, the values e(j) are quantized in the log domain. The first log value is quantized using a 7 bits uniform quantizer. Then the next bands are differentially encoded using a uniform log quantizer on 32 levels. An entropy coding method is then employed to encode the quantized values, with the following features:

The fully masked bands receive a given code, which is Huffman encoded.

Bands with quantized value outside [−7, 8] are encoded using an escape sequence, Huffman encoded, followed by a 4 bits code.

8 types of Huffman codes are designed for the resulting 18 codewords depending on the voiced/unvoiced decision on one hand, and on a classification of the bands (as for example described in “High-Quality Audio Transform Coding at 64 Kbps,” by Y. Mahieux & J. P. Petit, cited above) into 4 classes.

For tonal frames, the band with the maximum energy is first looked for, its number is encoded on 5 bits and the associated value on 7 bits. The other bands are differentially encoded relative to this maximum, in the log domain, on 4 bits.

The bits of the coefficients are dynamically allocated according to their perceptual importance. The basis of this allocation can be for example according to the allocation described in “High-Quality Audio Transform Coding at 64 Kbps,” by Y. Mahieux & J. P. Petit, cited above. The process is performed both at the ATC encoder and the ATC decoder side. A masking curve is calculated on a band per band basis, using the decoded spectrum envelope.

The bit allocation is obtained by an iterative procedure where at each iteration, for each band, the bit rate per coefficient R(f) is evaluated, then approximated to satisfy the coefficients' quantizers constraints. At the end of each iteration the global coefficients bit rate R′₀, is calculated. The iterative procedure stops whenever this value is closed to the target R′₀, or when a maximum number of iterations is reached.

Since the final R′₀is generally slightly different than R₀, the bit allocation is re-adjusted either by adding bit rate to the most perceptually important bands or by subtracting bit rate to the less perceptually important bands.

Quantization and encoding of the MDCT coefficients occurs in block 57. The value actually encoded for a coefficient k of a band j is y(k)/e′(j).

Two kinds of quantizers have been designed for the coefficients:

1. Scalar quantizers with odd numbers of reconstruction levels; and

2. Vector quantizers using algebraic codebooks of various sizes and dimensions.

For the scalar quantizers, two classes of quantizers may be designed depending on the v/uv nature of the frames. The masked coefficients receive the null value. This is allowed by the use of quantizers having zero as reconstruction level. Since the symmetry is needed, the quantizers were chosen to have an odd number of levels. This number ranges from 3 to 31.

Because these numbers are not powers of 2, the quantization indices corresponding to the coefficients of the scalar quantized bands are jointly encoded (see packing procedure below).

For the vector quantizers, the codebooks are embedded and designed for dimensions 3 to 15. For a given dimension, the codebooks (corresponding to various bit rates from 5 to 32, depending of the dimension) are composed of the union of permutation codes, all sign combinations being possible.

The quantization process may use an optimal fast algorithm (for example as described in Quantification vectorielle algébrique sphérique par le réseau de Barnes-Wall. Application au codage de la Parole, C. Lamblin, Ph.D, University of Sherbrooke, March 1988, hereby incorporated by reference herein) that takes advantage of the permutation codes structure.

The encoding of the selected codebook entry may use Schalkwijk's algorithm (as for example in Ouantification vectorielle algébrique sphérique par le réseau de Barnes-Wall. Application au codage de la Parole, cited above) for the permutations the signs being separately encoded.

Bitstream packing for the scalar codes is performed before the coefficients quantization begins.

The numbers of levels for the coefficients belonging to the scalar quantized bands are first ordered according to decreasing perceptual importance of the bands. Those numbers of levels are iteratively multiplied together until the product reaches a value closed to a power of 2, or (2³²−1). The corresponding coefficients quantization indices are jointly encoded. The process restarts from the first discarded number of level. At the end of the process the number of bits taken by the obtained codes is calculated. If it is greater than the allowed value, bit rate is decreased using the re-adjustment method mentioned above by subtracting bit rate to the less perceptually important bands. Bit rate taken to the bands encoded using vector quantizers does not affect bitstream packing. But if bit rate is taken into scalar quantized bands, the bitstream-packing algorithm should be restarted from the first code where a modification occurs. Since the bitstream-packing algorithm has ordered the number of levels according to decreasing importance of the bands, less important bands, that are more likely to be affected, were packed at the end of the procedure, which reduces the complexity of the bitstream packing.

The bitstream-packing algorithm generally converges at the second iteration.

The bits corresponding to the spectrum envelope, voiced/unvoiced and tonal/non tonal decisions are protected against isolated transmission errors using 9 protection bits.

The global bit allocation for the ATC mode is given by Table 5. The spectrum envelope has a variable number of bits due to entropy coding, typically in the range [85-90]. The number of bits allocated to the coefficients is equal to the total number of bits (depending on bit rate) minus the other numbers of bits.

TABLE 5
Bit allocation

| v/uv | t/nt | Spectrum envelope | Coefficients | Protection bits |
|---|---|---|---|---|
| 1 bit | 1 bit | variable number of | variable number of | 9 bits |
| | | bits | bits | |

The ATC decoder is shown in FIG. 6. Two modes of operation are run according to the bad frame indicator (BFI).

When BFI=0, the decoding scheme in valid frame decoder 71 follows the operation order as described with respect to FIG. 6. An inverse MDCT transform at block 73 is performed on the decoded MDCT coefficients and the synthesis signal is obtained in the time domain by the add-overlap of the sine-weighted samples of the previous and the current frame.

When BFI=1, a frame erasure is detected and the error concealment procedure in block 72 described below and illustrated by FIG. 8 is performed in order to recover the missing 320 MDCT coefficients of the current frame.

As described in FIG. 7, the valid frame decoder operates first through a demultiplexor 74. Spectrum envelope decoding occurs at block 75 for non-tonal and tonal frames. For non-tonal frames, the quantizer indices of the bands following the first one are obtained by comparing in decreasing probabilities order the bitstream to the Huffmann codes contained in stored tables. For tonal frames, the encoding process described above is reversed. Dynamic allocation in block 76 and inverse quantification of the MDCT coefficients in block 77 also takes place as in the encoder.

The error concealment procedure in block 72 of FIG. 6 is shown in FIG. 8. When an erased frame is detected by the BFI, the missing MDCT coefficients are calculated using extrapolated values of the output signal. The treatment differs for the first erased frame and the following successive frames. For the first erased frame the procedure is as follows:

1. a 14^{th} order LPC analysis is performed in block 91 using a 320 samples asymmetric window on the synthesized decoded speech available up to the erased frame;

2. if the past frame was tonal (t) or voiced (v), the pitch periodicity is computed in block 92 on the past synthesized signal by an LTP analysis. An integer lag is selected among 6 pre-selected candidates in the range [40, . . . 276] by favoring the lowest value;

3. the residual signal of the past synthesized speech is computed;

4. 640 samples of excitation signal are generated in block 93 from the past residual signal, using pitch periodicity in the voiced and tonal cases or a simple copy else;

5. 640 samples of extrapolated signal are obtained in block 94 by LPC filtering the excitation signal; and

6. an MDCT transform is performed in block 95 on this signal to recover the missing MDCT coefficients of the erased frame.

For the next successive erased frames, the LPC and the LTP coefficients calculated at the first erased frame are kept and only 320 samples of new extrapolated signal are calculated.

What is claimed is:

1. A method for signal controlled switching between audio coding schemes comprising:
receiving input audio signals;
classifying a first set of the input audio signals as speech or non-speech signals;
coding the speech signals using a time domain coding scheme; and
coding the nonspeech signals using a transform coding scheme.

2. The method as recited in claim 1 further comprising switching the input audio signals between a first encoder having the time domain coding scheme and a second encoder having the transform coding scheme as a function of the classifying.

3. The method as recited in claim 1 further comprising sampling the input audio signals so as to form a plurality of frames corresponding to the first set.

4. The method as recited in claim 1 wherein the classifying step includes computing two prediction gains and determining a difference between the two prediction gains.

5. The method as recited in claim 4 further comprising sampling the input audio signals so as to form a plurality of frames, the plurality of frames including a current frame to be classified and a previous frame, the classifying step further including determining a difference between LSF coefficients of the current frame and the previous frame.

6. The method as recited in claim 2 wherein the classifying step further includes postprocessing, the postprocessing determining if a degradation in a decoded output will occur.

7. The method as recited in claim 6 further comprising delaying the switching if the postprocessing determines that the degradation will occur.

8. The method as recited in claim 1 further comprising decoding the first set of signals, and when a switching between the speech signals and the non-speech signals occurs during decoding, forming an extrapolated signal.

9. The method as recited in claim 8 wherein the extrapolated signal is a function of previously decoded signals of the first set of signals.

10. The method as recited in claim 1 further comprising identifying an output bit rate, and if the output bit rate is 32 kb/s or greater, coding a second set of the audio signals using solely the transform coding scheme.

11. The method as recited in claim 10 wherein the classifying of the first set occurs only when the output bit rate is less than 32 kb/s.

12. The method as recited in claim 1 wherein the input audio signals are bandwidth limited to 7 kHz.

13. The method as recited in claim 1 wherein the time domain coding scheme is a CELP scheme.

14. The method as recited in claim 13 further comprising identifying an output bit rate, and if the bit rate is 16 kb/s, encoding only the input audio signals having a frequency less than 5 kHz.

15. The method as recited in claim 1 wherein the transform coding scheme is an ATC scheme.

16. The method as recited in claim 15 wherein the ATC scheme uses MDCT coefficients and further comprising identifying an output bit rate, and if the output bit rate is less than 32 kb/sec, disregarding a plurality of the MDCT coefficients.

17. A multicode coder comprising:
an audio signal input; and
a switch for receiving the audio signal inputs, the switch having a time domain encoder, a transform encoder, and a signal classifier for classifying the audio signals generally as speech or non-speech, the signal classifier directing speech audio signals to the time domain encoder and non-speech audio signals to the transform encoder.

18. The multicode coder as recited in claim 17 wherein the time domain encoder is a CELP encoder.

19. The multicode decoder as recited in claim 17 wherein the transform encoder is an ATC encoder.

20. A multicode decoder comprising:
a digital signal input;
a time domain decoder for selectively receiving data from the digital signal input;
a transform decoder for selectively receiving data from the digital signal input; and
an output switch for switching between the digital signal input between the time domain decoder and the transform decoder.
